(19) United States
(12) Patent Application Publication
(10) Pub. No.: US 2013/0269781 A1
(43) Pub. Date: Oct. 17, 2013

(54) POLYMER GEL ELECTROLYTE COMPOSITION, METHOD FOR PREPARING THE COMPOSITION AND DYE-SENSITIZED SOLAR CELL INCLUDING THE COMPOSITION

(71) Applicant: KOREA INSTITUTE OF SCIENCE AND TECHNOLOGY, Seoul (KR)

(72) Inventors: Min Jae KO, Seoul (KR); Doh-Kwon LEE, Seoul (KR); Hong Gon KIM, Seoul (KR); Jin Young KIM, Gyeonggi-do (KR); Ki Cheon YOO, Seoul (KR); Se Jeong PARK, Busan (KR); Bong Soo KIM, Seoul (KR)

(73) Assignee: KOREA INSTITUTE OF SCIENCE AND TECHNOLOGY, Seoul (KR)

(21) Appl. No.: 13/739,053

(22) Filed: Jan. 11, 2013

(30) Foreign Application Priority Data
Apr. 13, 2012 (KR) 10-2012-0038225

(51) Int. Cl. H01G 9/20

(52) U.S. Cl. CPC H01G 9/2018
USPC 136/263; 252/62.2

(57) ABSTRACT

Disclosed is a polymer gel electrolyte composition. The composition includes an aqueous solution of a polysaccharide-based polymer and a liquid electrolyte in which a redox derivative is mixed with an organic solvent. The composition is easy to inject. The composition is free from problems of leakage and volatilization, thus being environmentally friendly. Further disclosed is a highly efficient dye-sensitized solar cell using the composition. The dye-sensitized solar cell is stable for a long period of time and can be readily commercialized.

### CROSS-REFERENCE TO RELATED APPLICATIONS

This application claims priority under 35 U.S.C. §119 to Korean Patent Application No. 10-2012-0038225 filed on Apr. 13, 2012, in the Korean Intellectual Property Office, the disclosure of which is incorporated herein by reference in its entirety.

### BACKGROUND OF THE INVENTION

1. Field of the Invention

The present invention relates to a polymer gel electrolyte composition and a dye-sensitized solar cell using the same. More specifically, the present invention relates to a polymer gel electrolyte composition for a dye-sensitized solar cell including an aqueous polysaccharide-based polymer solution and a liquid electrolyte, and a highly efficient dye-sensitized solar cell using the polymer gel electrolyte composition that is environmentally friendly, highly stable, and commercially viable.

2. Description of the Related Art

Next-generation energy development has gained more importance due to the crisis of fossil fuel depletion and the recent serious problems of environmental pollution. Particularly, solar cells for directly converting solar energy emitted from sunlight into electrical energy produce a small amount of pollutants, make use of the inexhaustible energy resource, and can be used semi-permanently. Due to these advantages, solar cells are expected as future energy sources. Such solar cells are broadly classified into inorganic solar cells, dye-sensitized solar cells, and organic solar cells by the kind of material that they employ. Most of the inorganic solar cells use single crystalline silicon. Single crystal silicon solar cells can be advantageously fabricated in the form of thin films but suffer from the problems of high cost and low stability.

Dye-sensitized solar cells are photoelectrochemical solar cells and a prototype thereof was first presented by Gratzel et al., Switzerland, in 1991. Dye-sensitized solar cells require no junction at all, unlike p-n junction solar cells as general types of solar cells. A typical dye-sensitized solar cell includes a working electrode covered with porous TiO₂ and a counter electrode covered with platinum. An electrolyte through which ions migrate is positioned between the working electrode and the counter electrode. A photosensitive dye is adsorbed to the working electrode. The photosensitive dye can absorb visible light to create electron-hole pairs. The dye excites electrons, the excited electrons reach the counter electrode through the TiO₂ particles of the working electrode, and redox reactions proceed in the electrolyte to operate the dye-sensitized solar cell. Dye-sensitized solar cells are fabricated in a simple and economical manner and have high energy conversion efficiency compared to silicon solar cells. Due to these advantages, dye-sensitized solar cells have received attention as next-generation replacements for existing silicon solar cells. The energy conversion efficiency of dye-sensitized solar cells using liquid electrolytes was reported to be about 12% in 2011. An electrolyte of a dye-sensitized solar cell is required to have high ionic conductivity and good adhesion at the interface between a porous TiO₂ film and a counter electrode without the occurrence of leakage and evaporation of an organic solvent. The presence of redox couples dissolved in the organic solvent ensures high energy conversion efficiency of the dye-sensitized solar cell but makes sealing of the liquid electrolyte difficult. Further, the liquid electrolyte tends to be volatile or leak when the external temperature rises, resulting in poor characteristics of the dye-sensitized solar cell in terms of durability and stability.

Korean Patent Registration No. 10-2087849 discloses a dye-sensitized solar cell including a gel polymer electrolyte prepared by cross-linking. However, the fabrication of the dye-sensitized solar cell is complicated and further improvements are thus needed.

### PRIOR ART DOCUMENTS

### Patent Documents

Korean Patent Registration No. 10-2087849
Korean Patent Publication No. 10-2010-0024570
Korean Patent Registration No. 10-2011-0105449

### SUMMARY OF THE INVENTION

It is an object of the present invention to provide an environmentally friendly polymer gel electrolyte composition that is easy to inject and is free from problems of leakage and volatilization. It is another object of the present invention to provide a method for preparing the polymer gel electrolyte composition. It is still another object of the present invention to provide a highly efficient dye-sensitized solar cell using the polymer gel electrolyte composition that is stable for a long period of time, easy to fabricate, and commercially viable.

According to an aspect of the present invention, there is provided a polymer gel electrolyte composition for a dye-sensitized solar cell, including (a) an aqueous solution of a polysaccharide-based polymer, and (b) a liquid electrolyte in which a redox derivative is mixed with an organic solvent.

In an embodiment of the present invention, the polysaccharide-based polymer may be selected from, but not limited to, starch, cellulose, pectin, guar gum, alginate, carrageenan, xanthan gum, dextrin, and mixtures thereof. Of these, xanthan gum is preferably used due to its thixotropy.

In an embodiment of the present invention, the solvent of the aqueous polymer solution may be selected from, but not limited to, distilled water, glycerol, ethylene glycol, propylene glycol, and mixtures thereof.

In a further embodiment of the present invention, the redox derivative may be selected from the group consisting of lithium iodide, sodium iodide, potassium iodide, lithium bromide, sodium bromide, potassium bromide, quaternary ammonium salts, imidazolium salts, pyridinium salts, pyrrolidinium salts, pyrazolidium salts, isothiazolidinium salts, isoxazolidinium salts, and cobalt-based nitrogen-containing heterocyclic compounds; and the organic solvent may be selected from the group consisting of acetonitrile, 3-methoxypropionitrile, ethylene carbonate, propylene carbonate, dimethyl carbonate, diethyl carbonate, ethyl methyl carbonate, polyethylene glycol, polypropylene glycol, tetrahydrofuran, and γ-butyrolactone.

In an embodiment of the present invention, the polysaccharide-based polymer is preferably present in an amount of 1 to 5% by weight, based on the weight of the aqueous solution; and the aqueous polysaccharide-based polymer solution and the liquid electrolyte are preferably present in amounts of 50 to 60% by weight and 40 to 50% by weight, respectively, based on the weight of the polymer gel electrolyte composition.

According to another aspect of the present invention, there is provided a method for preparing a polymer gel electrolyte composition for a dye-sensitized solar cell, the method including 1) dispersing a polysaccharide-based polymer in a solvent to prepare an aqueous polymer gel solution, 2) mixing a redox derivative with an organic solvent to prepare a liquid electrolyte, and 3) mixing the aqueous polysaccharide-based polymer gel solution with the liquid electrolyte. In step 3), the aqueous polysaccharide-based polymer gel solution is preferably heated to 30 to 80° C. before mixing with the liquid electrolyte.

According to yet another aspect of the present invention, there is provided a highly stable, efficient dye-sensitized solar cell including the polymer gel electrolyte composition between a working electrode and a counter electrode.

The use of thixotropic xanthan gum as the polysaccharide-based polymer facilitates injection of the polysaccharide-based polymer gel electrolyte into the porous working electrode to increase the adhesion of the polysaccharide-based polymer gel electrolyte to the electrode, leading to an improvement in ionic conductivity and contributing to an increase in photocurrent. In addition, xanthan gum has a network structure in which the liquid electrolyte can be trapped, to prevent the organic solvent from leakage or evaporation, which is a problem of the prior art. Furthermore, the polymer gel electrolyte of the present invention is environmentally friendly because it is based on water, and maintains its initial efficiency while preventing a reduction in efficiency caused by moisture permeation over a long period of time, achieving long-term stability of the dye-sensitized solar cell.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a cross-sectional view of a dye-sensitized solar cell including a liquid electrolyte, which was fabricated in Comparative Example 1;

FIG. 2 is a cross-sectional view of a dye-sensitized solar cell including a gel electrolyte using a polysaccharide-based polymer, which was fabricated in Example 1;

FIG. 3 illustrates a basic structure of xanthan gum as a main component of a polymer gel electrolyte used in Example 1; and

FIG. 4 shows photographs of a gel electrolyte using a polysaccharide-based polymer, which was prepared in Example 1: (a) shows a gel state of the gel electrolyte when no external force was applied thereto, and (b) shows a fluid state of the gel electrolyte after shaking by an artificial force.

### DETAILED DESCRIPTION OF THE INVENTION

The present invention will now be described in more detail.

The present invention provides a polymer gel electrolyte composition for a dye-sensitized solar cell, including (a) an aqueous solution of a polysaccharide-based polymer, and (b) a liquid electrolyte in which a redox derivative is mixed with an organic solvent.

The present invention also provides a method for preparing a polymer gel electrolyte composition for a dye-sensitized solar cell, the method including 1) dispersing a polysaccharide-based polymer in a solvent to prepare an aqueous polymer solution, 2) mixing a redox derivative with an organic solvent to prepare a liquid electrolyte, and 3) mixing the aqueous polysaccharide-based polymer solution with the liquid electrolyte.

Examples of polysaccharide-based polymers suitable for use in the present invention include, but are not limited to, starch, cellulose, pectin, guar gum, alginate, carrageenan, xanthan gum, and dextrin. These polysaccharide-based polymers may be used alone or as a mixture thereof.

Xanthan gum is particularly preferred due to its thixotropy. Thixotropic xanthan gum loses its viscosity at a constant shear rate with the passage of time and returns to its original state or properties when the application of external force is stopped. The use of thixotropic xanthan gum facilitates injection of the polymer gel electrolyte composition into a porous working electrode to increase the adhesion of the polymer gel electrolyte composition to the electrode, leading to an improvement in ionic conductivity and contributing to an increase in photocurrent. In addition, xanthan gum has a network structure in which the liquid electrolyte can be trapped, to prevent the organic solvent from leakage or evaporation, which is a problem of the prior art. Thus, xanthan gum is very suitable for use as the polysaccharide-based polymer in the polymer gel electrolyte.

Examples of solvents suitable to disperse the polysaccharide-based polymer include distilled water, glycerol, ethylene glycol, and propylene glycol. The use of distilled water is preferred.

The redox derivative used in the liquid electrolyte refers to a substance that plays a role in participating in reversible redox reactions in the electrolyte to transfer electrons between a working electrode and a counter electrode, and can provide redox couples, for example, an I⁻/I³⁻ redox couple. The I⁻/I³⁻ redox couple may be prepared by dissolving iodine in a molten salt of an iodide or dissolving iodine or an iodide in a molten salt of a compound other than iodides.

Specific examples of redox derivatives suitable for use in the liquid electrolyte include, but are not limited to: metal halides, such as lithium iodide, sodium iodide, potassium iodide, lithium bromide, sodium bromide, and potassium bromide; quaternary ammonium salts; and nitrogen-containing heterocyclic compounds, such as imidazolium salts, pyridinium salts, pyrrolidinium salts, pyrazolidium salts, isothiazolidinium salts, isoxazolidinium salts, and cobalt-based nitrogen-containing heterocyclic compounds. Any redox derivative commonly used in liquid electrolytes of fuel cells may be used without limitation.

Examples of organic solvents suitable for use in the liquid electrolyte include, but are not limited to, acetonitrile, 3-methoxypropionitrile, ethylene carbonate, propylene carbonate, dimethyl carbonate, diethyl carbonate, ethyl methyl carbonate, polyethylene glycol, polypropylene glycol, tetrahydrofuran, and γ-butyrolactone. Any non-volatile, high boiling point organic solvent commonly used in liquid electrolytes of fuel cells may be used without limitation.

In one embodiment of the present invention, the polysaccharide-based polymer is preferably present in an amount of 1 to 5% by weight, based on the weight of the aqueous solution, and the polysaccharide-based polymer gel electrolyte may be prepared by mixing 50 to 60% by weight of the aqueous solution including 1 to 5% by weight of the polysaccharide-based polymer with 40 to 50% by weight of the liquid electrolyte. If the polysaccharide-based polymer, such as xanthan gum, is present in an amount of less than 1% by weight, the viscosity of the polysaccharide-based polymer gel electrolyte may be too low to exhibit thixotropy. Meanwhile, if the polysaccharide-based polymer is present in an amount exceeding 5% by weight, the polysaccharide-based polymer gel electrolyte may be ultra-highly viscous, which makes it impossible to inject the polysaccharide-based polymer gel electrolyte. If the aqueous polymer solution is present in an amount of less than 50% by weight, mixing with the liquid electrolyte may be substantially impossible. Meanwhile, if the aqueous polymer solution is present in an amount exceeding 60% by weight, the presence of a small amount of the liquid electrolyte may lead to a marked reduction in photoelectric conversion efficiency.

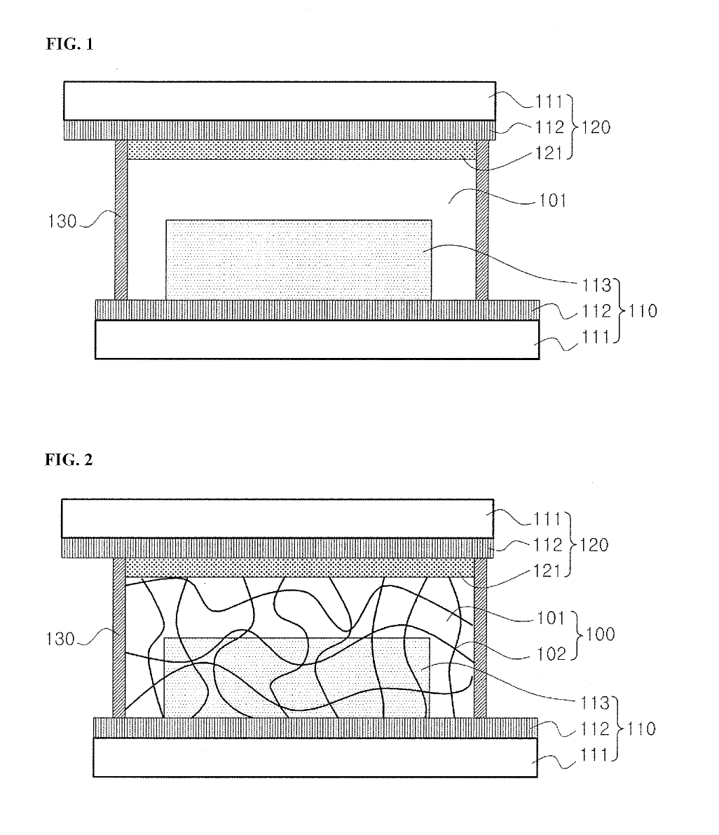

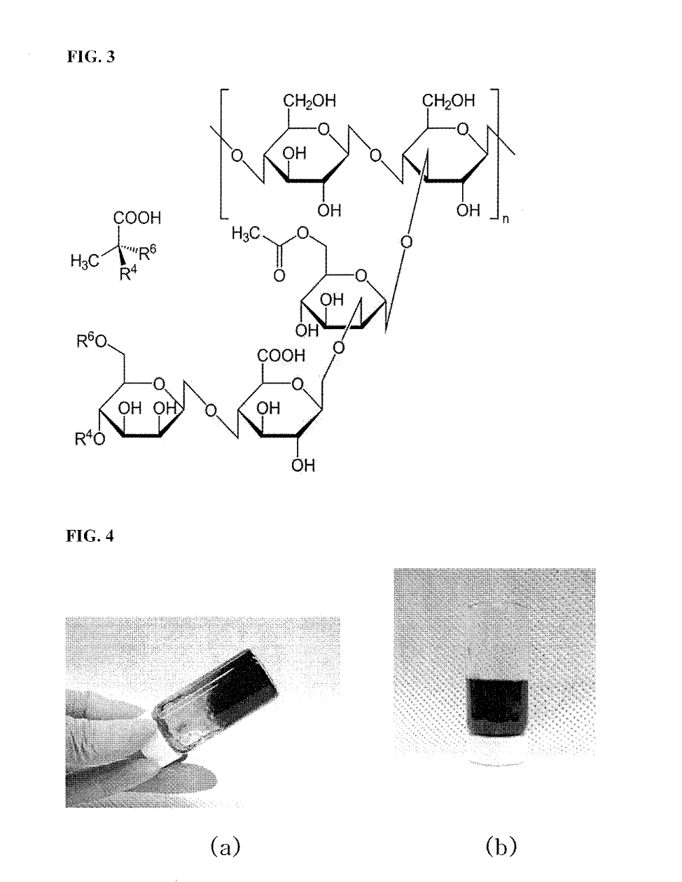

The present invention also provides a dye-sensitized solar cell including the polysaccharide-based polymer gel electrolyte composition between a working electrode and a counter electrode. According to one embodiment of the present invention, the dye-sensitized solar cell includes a working electrode 110, a counter electrode 120 spaced a certain distance from the working electrode 110 and arranged to face the working electrode 110, and an electrolyte 100 filled in a space between the working electrode and the counter electrode, as illustrated in FIGS. 1 and 2.

The arrangement of the working electrode and the counter electrode is accomplished by positioning the working electrode and the counter electrode such that a metal oxide layer of the working electrode faces a metal layer of the counter electrode face, inserting a 20 to 100 μm thick thermoplastic film 130 between edge portions of the two electrodes, and maintaining the resulting structure at a temperature of 60 to 120° C. for 5 to 20 seconds to bring the electrodes into close contact with each other. Subsequently, the electrolyte solution is injected into a space between the working electrode and the counter electrode through a hole, which has been previously drilled.

For example, the dye-sensitized solar cell may include a TiO₂ working electrode to which a dye is adsorbed, a platinum counter electrode, and the polysaccharide-based polymer gel electrolyte serving as an ionic path between the working electrode and the counter electrode. In the present invention, the electrolyte solution may also be heated after being injected between the working electrode and the counter electrode. For example, the aqueous solution of xanthan gum as the polysaccharide-based polymer becomes thin when a shear stress is applied thereto. The thixotropy of xanthan gum facilitates injection of the aqueous polymer solution. As a result, the aqueous polymer solution easily permeates between the porous TiO₂ particles and comes into contact with the TiO₂ particles. That is, the electrolyte solution is more readily injected between the working electrode and the counter electrode than other polymer gel electrolytes, and forms a stable polymer gel electrolyte between the working electrode and the counter electrode when an external force is not applied after heat treatment.

The working electrode 100 may be formed by any suitable method known in the art. The working electrode 100 may include a substrate and a dye-adsorbed porous film. Examples of substrates suitable for use in the working electrode 100 include metal substrates, glass substrates, plastic substrates, fabric substrates, and ceramic substrates. A transparent conducting oxide (TCO) electrode may be formed on the substrate. Examples of such transparent conducting oxides include, but are not limited to, SnO₂:F and ITO. The transparent conducting oxide electrode may be any conducting film well known in the art. The conducting electrode may be formed by coating a conducting film including F-doped SnO₂:SnO₂:F (FTO), ITO, a metal electrode having an average thickness of 1 to 1000 nm, a metal nitride, a metal oxide, a carbon compound, or a conducting polymer on the substrate. That is, as illustrated in FIG. 1, the working electrode 110 may include a substrate 111, a conducting film 112 formed on the substrate, and a dye-adsorbed porous film 113.

Examples of metal nitrides suitable for use in the present invention include nitrides of Group IVB metal elements, nitrides of Group VB metal elements, nitrides of Group VIB metal elements, aluminum nitride, gallium nitride, indium nitride, silicon nitride, and germanium nitride. These metal nitrides may be used alone or as a mixture thereof.

Metal oxide nanoparticles, preferably those having a particle size of 10 to 100 nm, may also be used in the present invention. The metal oxide nanoparticles may be selected from the group consisting of tin (Sn) oxide, antimony (Sb)-doped tin (Sn) oxide, niobium (Nb)-doped tin (Sn) oxide, fluorine-doped tin (Sn) oxide, indium (In) oxide, tin-doped indium (In) oxide, zinc (Zn) oxide, aluminum (Al)-doped zinc (Zn) oxide, boron (B)-doped zinc (Zn) oxide, gallium (Ga)-doped zinc (Zn) oxide, hydrogen (H)-doped zinc (Zn) oxide, indium (In)-doped zinc (Zn) oxide, yttrium (Y)-doped zinc (Zn) oxide, titanium (Ti)-doped zinc (Zn) oxide, silicon (Si)-doped zinc (Zn) oxide, tin (Sn)-doped zinc (Zn) oxide, magnesium (Mg) oxide, cadmium (Cd) oxide, magnesium zinc (MgZn) oxide, indium zinc (InZn) oxide, copper aluminum (CuAl) oxide, silver (Ag) oxide, gallium (Ga) oxide, zinc tin oxide (ZnSnO), titanium oxide (TiO₂), zinc indium tin (ZIS) oxide, nickel (Ni) oxide, rhodium (Rh) oxide, ruthenium (Ru) oxide, iridium (Ir) oxide, copper (Cu) oxide, cobalt (Co) oxide, tungsten (W) oxide, titanium (Ti) oxide, zirconium (Zr) oxide, strontium (Sr) oxide, lanthanum (La) oxide, vanadium (V) oxide, molybdenum (Mo) oxide, niobium (Nb) oxide, aluminum (Al) oxide, yttrium (Y) oxide, scandium (Sc) oxide, samarium (Sm) oxide, strontium titanium (SrTi) oxide nanoparticles, and mixtures thereof. The use of titanium oxide nanoparticles is preferred.

Examples of carbon compounds suitable for use in the present invention include, but are not limited to, activated carbon, graphite, carbon nanotubes, carbon black, graphene, and mixtures thereof. The conducting polymer may be selected from the group consisting of poly(3,4-ethylenedioxythiophene)-(poly(styrenesulfonate) (PEDOT-PSS), polyaniline-CSA, pentacene, polyacetylene, poly(3-hexylthiophene) (P3HT), polysiloxane carbazole, polyaniline, polyethylene oxide, poly(1-methoxy-4-(0-Disperse Red 1)-2,5-phenylene-vinylene), polyindole, polycarbazole, polypyridiazine, polyisothianaphthalene, polyphenylene sulfide, polyvinyl pyridine, polythiophene, polyfluorene, polypyridine, polypyrrole, polysulfur nitride, copolymers thereof, and mixtures thereof.

The dye-adsorbed porous film 113 is a layer of metal nanoparticles, such as a film of TiO₂ nanoparticles, to constitute a portion of the working electrode. The thickness of the porous film is not particularly limited but is preferably from 1 to 40 μm.

The dye-adsorbed porous film may be formed using a paste including metal oxide nanoparticles, a binder and a solvent, together with a photosensitive dye, by a general method known in the art. For example, the porous film may be formed by applying a paste including metal oxide nanoparticles, a binder and a solvent to a predetermined thickness onto a first substrate, followed by heat treatment at a temperature of 450 to 500° C. for 1 to 2 hours. The working electrode is produced by adsorbing a dye to the surface of the porous film.

The porous film may include nanoparticles of one or more metal oxides selected from the group consisting of tin (Sn) oxide, antimony (Sb)-doped tin (Sn) oxide, niobium (Nb)-doped tin (Sn) oxide, fluorine-doped tin (Sn) oxide, indium (In) oxide, tin-doped indium (In) oxide, zinc (Zn) oxide, aluminum (Al)-doped zinc (Zn) oxide, boron (B)-doped zinc (Zn) oxide, gallium (Ga)-doped zinc (Zn) oxide, hydrogen (H)-doped zinc (Zn) oxide, indium (In)-doped zinc (Zn) oxide, yttrium (Y)-doped zinc (Zn) oxide, titanium (Ti)-doped zinc (Zn) oxide, silicon (Si)-doped zinc (Zn) oxide, tin (Sn)-doped zinc (Zn) oxide, magnesium (Mg) oxide, cadmium (Cd) oxide, magnesium zinc (MgZn) oxide, indium zinc (InZn) oxide, copper aluminum (CuAl) oxide, silver (Ag) oxide, gallium (Ga) oxide, zinc tin oxide (ZnSnO), titanium oxide (TiO₂), zinc indium tin (ZIS) oxide, nickel (Ni) oxide, rhodium (Rh) oxide, ruthenium (Ru) oxide, iridium (Ir) oxide, copper (Cu) oxide, cobalt (Co) oxide, tungsten (W) oxide, titanium (Ti) oxide, zirconium (Zr) oxide, strontium (Sr) oxide, lanthanum (La) oxide, vanadium (V) oxide, molybdenum (Mo) oxide, niobium (Nb) oxide, aluminum (Al) oxide, yttrium (Y) oxide, scandium (Sc) oxide, samarium (Sm) oxide, and strontium titanium (SrTi) oxide.

The photosensitive dye has a band gap of 1.55 eV to 3.1 eV. Within this range, the photosensitive dye can absorb visible light. The photosensitive dye may be, for example, an organic-inorganic composite dye including a metal or metal composite, an organic dye, or a mixture thereof. The organic-inorganic composite dye may be, for example, one that includes an element selected from the group consisting of aluminum (Al), platinum (Pt), palladium (Pd), europium (Eu), lead (Pb), iridium (Ir), ruthenium (Ru), and composites thereof.

A film of nanoparticles, such as Pt nanoparticles, is formed to constitute a portion of the counter electrode 120. The film is preferably formed using nanoparticles of one or more materials selected from the group consisting of platinum (Pt), activated carbon, graphite, carbon nanotubes, carbon black, p-type semiconductors, poly(3,4-ethylenedioxythiophene)-(poly(styrenesulfonate) (PEDOT-PSS), polyaniline-CSA, pentacene, polyacetylene, poly(3-hexylthiophene) (P3HT), polysiloxane carbazole, polyaniline, polyethylene oxide, poly(1-methoxy-4-(0-Disperse Red 1)-2,5-phenylene-vinylene), polyindole, polycarbazole, polypyridiazine, polyisothianaphthalene, polyphenylene sulfide, polyvinyl pyridine, polythiophene, polyfluorene, polypyridine, polypyrrole, polysulfur nitride, derivatives thereof, copolymers thereof, and composites thereof.

The present invention will be explained in more detail with reference to the following examples. These examples are provided to assist in further understanding of the invention and are not intended to limit the scope of the invention.

### EXAMPLES

### Example 1

### Fabrication of Dye-Sensitized Solar Cell Using Xanthan Gum Gel Electrolyte

5 wt % of xanthan gum powder was mixed in distilled water. The mixture was homogeneously dispersed with stirring for 3 hr to prepare an aqueous polymer gel solution. Then, 1.97 M 1-methyl-3-propylimidazolium iodide (PMII), 0.3 M I₂, 0.75 M tert-butyl pyridine (tBP), and 0.1M guanidinium thiocyanate (GSCN) were dissolved in 3-methoxypropionitrile to prepare a liquid electrolyte.

The aqueous xanthan gum solution was heated to 30-80° C., and then the liquid electrolyte was added dropwise thereto with stirring to prepare a polymer gel electrolyte composition. The aqueous xanthan gum solution and the liquid electrolyte were used in a ratio of 50:50.

A conducting FTO glass substrate (Philkington, 2.2 cm thick, 8 Ω/sq.) was prepared as a substrate for a working electrode (111 and 112 in FIG. 2). Subsequently, a paste including 18.5 wt % of titanium oxide nanoparticles having an average diameter of 20 nm, 0.05 wt % of ethyl cellulose as a binder polymer, and the balance of terpineol as a solvent was applied onto the glass substrate by doctor blade coating, followed by heat treatment at 500° C. for 30 mM to form a 20 μm thick porous film including the metal oxide nanoparticles.

Subsequently, the substrate, on which the porous film had been formed, was dipped in an acetonitrile/1-butanol solution including 0.3 mM (cis-bis(thiocyanato) (2,20-bipyridyl-4,40-dicarboxylato) {4,40-bis[2-(4-hexylsulfanylphenyl)vinyl]-2,20-bipyridine}ruthenium(II) mono(tetrabutylammonium) salt) (TG6) as a photosensitive dye for 12 hr to produce a working electrode in which the photosensitive dye was adsorbed to the surface of the porous film.

A transparent glass substrate formed with a transparent conducting oxide (fluorine-doped tin oxide (FTO)) layer thereon was prepared. A solution of hexachloroplatinic acid (H₂PtCl₆) in 2-propanol was dropped onto the transparent conducting oxide layer of the substrate, followed by heat treatment at 400° C. for 20 min to form a platinum layer, completing the production of a counter electrode as an anode.

The gel type electrolyte was injected into a space between the working electrode and the counter electrode, and sealed with a general polymer resin to fabricate a dye-sensitized solar cell having the structure of FIG. 2.

### Comparative Example 1

### Fabrication of Dye-Sensitized Solar Cell Using Liquid Electrolyte

1.97 M 1-methyl-3-propylimidazolium iodide (PMII), 0.3 M I₂, 0.75 M tert-butyl pyridine (tBP), and 0.1M guanidinium thiocyanate (GSCN) were dissolved in a mixture of 3-methoxypropionitrile and water (50:50 (v/v)) to prepare a liquid electrolyte.

A working electrode and a counter electrode were produced in the same manner as in Example 1. The liquid electrolyte was injected into a space between the working electrode and the counter electrode, and sealed with a general polymer resin to fabricate a dye-sensitized solar cell having the structure of FIG. 1.

### Experimental Example 1

### Measurement of Energy Conversion Efficiencies

The energy conversion efficiencies (%) of the dye-sensitized solar cells fabricated in Example 1 and Comparative Example 1 were measured using a 1.5AM 100 mW/cm² solar simulator with a Xe lamp (1600 W, YAMASHITA DENSO), an AM1.5 filter and Keithley SMU2400. The results are shown in Table 1.

TABLE 1

| Sample | Efficiency (%) |
|---|---|
| Example 1 | 4.78 |
| Comparative Example 1 | 4.99 |

As can be seen from the results in Table 1, there was no significant difference in efficiency between the dye-sensitized solar cell of Example 1 using the xanthan gum gel electrolyte and the dye-sensitized solar cell of Comparative Example 1 using the liquid electrolyte containing 50% water. These results reveal that a highly viscous electrolyte can be prepared without a reduction in the conductivity of redox ions as in Example 1.

### Experimental Example 2

### Measurement of Stability of the Cells

In this example, the efficiencies of the dye-sensitized solar cells fabricated in Example 1 and Comparative Example 1 were measured as a function of time to investigate the stability of the solar cells. Specifically, the efficiencies of the dye-sensitized solar cells were measured after storage for 1,000 hr in a darkroom at a temperature of 60° C. and a humidity of 60%. The results are shown in Table 2.

TABLE 2

| | | | Reduction rate |
|---|---|---|---|
| Sample | Initial (%) | After 1000 hr (%) | (%) |
| Example 1 | 4.78 | 4.52 | 5.44 |
| Comparative Example 1 | 4.99 | 3.82 | 23.45 |

Referring to the results in Table 2, the time-dependent performance of the dye-sensitized solar cell of Example 1 using the xanthan gum gel electrolyte was more stable than that of the dye-sensitized solar cell of Comparative Example 1 using the liquid electrolyte. These results can be explained by the network structure of the gel polymer in which the electrolyte solution is trapped, to prevent leakage of the electrolyte solution. Therefore, the efficiency of the polymer gel electrolyte solution could be less reduced than that of the liquid electrolyte system. In addition, the dye-sensitized solar cell of Example 1 was very stable even at a high humidity (60%).

What is claimed is:

1. A polymer gel electrolyte composition for a dye-sensitized solar cell, comprising (a) an aqueous solution of a polysaccharide-based polymer, and (b) a liquid electrolyte in which a redox derivative is mixed with an organic solvent.

2. The polymer gel electrolyte composition according to claim 1, wherein the polysaccharide-based polymer is selected from starch, cellulose, pectin, guar gum, alginate, carrageenan, xanthan gum, dextrin, and mixtures thereof.

3. The polymer gel electrolyte composition according to claim 1, wherein the polysaccharide-based polymer is xanthan gum.

4. The polymer gel electrolyte composition according to claim 1, wherein the solvent of the aqueous solution is selected from distilled water, glycerol, ethylene glycol, propylene glycol, and mixtures thereof.

5. The polymer gel electrolyte composition according to claim 1, wherein the redox derivative is selected from the group consisting of lithium iodide, sodium iodide, potassium iodide, lithium bromide, sodium bromide, potassium bromide, quaternary ammonium salts, imidazolium salts, pyridinium salts, pyrrolidinium salts, pyrazolidium salts, isothiazolidinium salts, isoxazolidinium salts, and cobalt-based nitrogen-containing heterocyclic compounds.

6. The polymer gel electrolyte composition according to claim 1, wherein the organic solvent is selected from the group consisting of acetonitrile, 3-methoxypropionitrile, ethylene carbonate, propylene carbonate, dimethyl carbonate, diethyl carbonate, ethyl methyl carbonate, polyethylene glycol, polypropylene glycol, tetrahydrofuran, and γ-butyrolactone.

7. The polymer gel electrolyte composition according to claim 1, wherein the polysaccharide-based polymer is present in an amount of 1 to 5% by weight, based on the weight of the aqueous solution.

8. The polymer gel electrolyte composition according to claim 1, wherein the aqueous polysaccharide-based polymer solution and the liquid electrolyte are present in amounts of 10 to 80% by weight and 20 to 90% by weight, respectively, based on the weight of the polymer gel electrolyte composition.

9. A method for preparing a polymer gel electrolyte composition for a dye-sensitized solar cell, the method comprising
1) dispersing a polysaccharide-based polymer in a solvent to prepare an aqueous polymer gel solution,
2) mixing a redox derivative with an organic solvent to prepare a liquid electrolyte, and
3) mixing the aqueous polysaccharide-based polymer gel solution with the liquid electrolyte.

10. The method according to claim 9, wherein, in step 3), the aqueous polysaccharide-based polymer gel solution is heated before mixing with the liquid electrolyte.

11. The method according to claim 10, wherein the aqueous polysaccharide-based polymer gel solution is heated to a temperature of 30 to 80° C.

12. The method according to claim 9, wherein the polysaccharide-based polymer is selected from starch, cellulose, pectin, guar gum, alginate, carrageenan, xanthan gum, dextrin, and mixtures thereof.

13. The method according to claim 9, wherein the polysaccharide-based polymer is xanthan gum.

14. The method according to claim 9, wherein the solvent of the aqueous solution is selected from distilled water, glycerol, ethylene glycol, propylene glycol, and mixtures thereof.

15. The method according to claim 9, wherein the redox derivative is selected from the group consisting of lithium iodide, sodium iodide, potassium iodide, lithium bromide, sodium bromide, potassium bromide, quaternary ammonium salts, imidazolium salts, pyridinium salts, pyrrolidinium salts, pyrazolidium salts, isothiazolidinium salts, isoxazolidinium salts, and cobalt-based nitrogen-containing heterocyclic compounds.

16. The method according to claim 9, wherein the organic solvent is selected from the group consisting of acetonitrile, 3-methoxypropionitrile, ethylene carbonate, propylene carbonate, dimethyl carbonate, diethyl carbonate, ethyl methyl carbonate, polyethylene glycol, polypropylene glycol, tetrahydrofuran, and γ-butyrolactone.

17. The method according to claim 9, wherein the polysaccharide-based polymer is present in an amount of 1 to 5% by weight, based on the weight of the aqueous solution.

18. The method according to claim 9, wherein the aqueous polysaccharide-based polymer solution and the liquid electrolyte are present in amounts of 10 to 80% by weight and 20 to 90% by weight, respectively, based on the weight of the polymer gel electrolyte composition.

19. A dye-sensitized solar cell comprising the polymer gel electrolyte composition according to claim 1 between a working electrode and a counter electrode.
